(19) United States
(12) Patent Application Publication
(10) Pub. No.: US 2003/0190903 A1
(43) Pub. Date: Oct. 9, 2003

(54) Zero-loss front end for wireless communication

(75) Inventor: Raviv Melamed, Nes Ziona (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: ENVARA LTD.

(21) Appl. No.: 10/425,633

(22) Filed: Apr. 30, 2003

Related U.S. Application Data
(63) Continuation-in-part of application No. 10/362,795.
(63) A 371 of international application No. PCT/US01/21795, filed on Jul. 11, 2001.
(60) Provisional application No. 60/397,102, filed on Jul. 22, 2002.

(51) Int. Cl. H04B 1/38; H04M 1/00

(52) U.S. Cl. 455/277.1; 455/293; 455/550.1; 455/574

(57) ABSTRACT

A wireless communication device includes a transceiver front end and at least two receive antennas. Each receive antenna is operationally connected to a receiver front end of the transceiver front end only via a respective low noise amplifier. Receive diversity is provided by providing operating power only to one of the low noise amplifiers, for example, only to the low noise amplifier of the receive antenna that receives the largest portion of the received RF power.

This is a continuation-in-part of U.S. provisional patent application No. 60/397,102, filed Jul. 22, 2002. This also is a continuation-in-part of U.S. patent application Ser. No. 10/362,795, filed Feb. 27, 2003.

### FIELD AND BACKGROUND OF THE INVENTION

The present invention relates to wireless communication and, more particularly, to a low-cost, zero-loss front end for applications such as wireless LAN (WLAN).

WLAN is just beginning to enjoy a growing momentum in the marketplace as more and more users take advantage of the freedom to access their data wirelessly where the data is most useful. Significant recent advances in RF technology underpin this wireless networking revolution.

Conventional designs of the half-duplex radios employed in WLAN and in other, similar applications use the same antennas for both reception and transmission. One such design, that uses antenna diversity for both transmission and reception paths, is illustrated in FIG. 1, which is adapted from PCT application WO 02/31999. (Note that WO 02/31999 is incorporated by reference for all purposes as if fully set forth herein.) FIG. 1 shows a wireless communication device 100 that includes a transmitter front end 130 and a receiver front end 132. Transmitter front end 130 includes an amplifier 102, an up-converter 104, an automatic gain control (AGC) amplifier 106 and a power amplifier 108. Receiver front end 132 includes an amplifier 112, a down-converter 114, an AGC amplifier 116 and a low noise amplifier 118. A signal 140 to be transmitted is supplied as an input baseband (BB) frequency signal or as an input intermediate frequency (IF) signal from a modem (not shown). Signal 140 is frequency up-converted by up-converter 104. A received signal 142, as down-converted by down-converter 114, is provided as an output BB or IF signal to the modem. A voltage-controlled oscillator (VCO) 122 controlled by a phase lock loop (PLL) 120 is a synthesized frequency source that generates the local oscillator frequencies for up-converter 104 and down-converter 114.

As a half-duplex device with antenna diversity, device 100 alternates between transmitting RF signals via one of two antennas 124 and 126 and receiving RF signals via one of antennas 124 and 126. To this end, antennas 124 and 126 are coupled to transmitter front end 130 and to receiver front end 132 via two switches 110 and 111. Switch 110 is for switching between transmission and reception. Which of the two antennas, antenna 124 or antenna 126, is used for transmission and reception is determined by a diversity control mechanism 150. Typically, this determination is based on which of the two antennas is receiving the stronger signal and then switches switch 111 to that antenna; but other criteria also can be used, as is known in the art. As described in WO 02/31999, the reason for using two antennas is to provide receive diversity to overcome multi-path problems. Transmitter 130, receiver 132, PLL 120 and VCO 122 constitute a front end 160 of a transceiver that includes diversity control mechanism 150 as well as other components that are not shown. For example, diversity control mechanism 150 often is part of the modem: the measurements upon which antenna selection is based are performed by the modem, and only a diversity control signal is sent to switch 111.

A typical low-cost, on-board switch such as switch 110 or 111 has an insertion loss of about 1.5 dB, for a combined loss of 3 dB in both transmission and reception. To overcome this insertion loss, WO 02/31999 uses the configuration illustrated in FIG. 2. Wireless communication device 200 of FIG. 2 is similar to device 100, but includes three antennas: a transmit antenna 228 and two receive antennas 224 and 226. Transmit antenna 228 is used only for transmission. Receive antennas 224 and 226 are used only for reception, via a single switch 210. As in device 100, diversity control mechanism 150 determines which of receive antennas 224 and 226 should be used, typically by measuring which of receive antennas 224 and 226 is receiving the stronger signal, and then switches switch 210 to that antenna.

By not transmitting via any switches at all, device 200 saves 3 dB on the transmission path vs. device 100. Device 200 therefore can achieve then same performance as device 100 using a power amplifier 108 rated at half the power of power amplifier 108 of device 100. Alternatively, device 200 uses the same power amplifier 108 as device 100 to radiate 3 dB more output power, thereby achieving a correspondingly greater transmission range.

By using only one switch in its reception path, device 200 saves 1.5 dB vs. device 100. For wireless LAN applications such as IEEE 802.11a+b+g, and for other similar applications, this yields an approximately 12% increase in indoor coverage range. In the context of a WLAN, this means that fewer access points are needed for a given structure or area with no loss in network capacity. Alternatively, the reception sensitivity is increased by 1.5 dB. Nevertheless, the presence of switch 210 in the receive path of device 200 means that device 200 saves only 1.5 dB vs. device 100 in its reception path, rather than the full 3 dB that is saved by not using any switches in the transmission path and that would be saved if there were no switches in the reception path.

There is thus a widely recognized need for, and it would be highly advantageous to have, a wireless communication device that achieves receive diversity without using switches.

### SUMMARY OF THE INVENTION

According to the present invention there is provided a wireless communication device including: (a) a transceiver front end including a receiver front end; and (b) at least two receive antennas, each receive antenna operationally connected to the receiver front end only via a respective low noise amplifier.

According to the present invention there is provided a method of operating a RF receiver front end, including the steps of: (a) providing at least two receive antennas, each receive antenna operationally connected to the receiver front end only via a respective low noise amplifier; (b) selecting only one of the receive antennas to receive RF signals; and (c) providing operating power only to the respective low noise amplifier of the selected receive antenna.

Preferably, the transceiver front end also includes a transmitter front end, and the device of the present invention also includes a transmit antenna that is operationally connected to the transmitter front end. Most preferably, the transmit antenna is connected to the transmitter front end only via a respective power amplifier.

Preferably, the device of the present invention also includes a mechanism for achieving receive diversity by alternating operating power among the low noise amplifiers, so that only one low noise amplifier at a time is provided with operating power. In one embodiment of the present invention, this mechanism periodically measures the RF signal power as received by each of the receive antennas and then provides operating power only to the low noise amplifier of the receive antenna that receives the signal with the largest RF power. Most preferably, the received RF signal power is measured in either the 5 Gigahertz frequency band or the 2.4 Gigahertz frequency band that are commonly used in WLAN applications.

Preferably, the transceiver front end and the low noise amplifiers are integrated in a single common RF integrated circuit (RFIC) chip. Most preferably, the chip is silicon-based.

The scope of the present invention also includes a WLAN that includes one or more wireless communication devices of the present invention.

Although the primary intended application of the present invention is to WLAN, the scope of the present invention extends to all RF systems to which the principles of the present invention are applicable.

### BRIEF DESCRIPTION OF THE DRAWINGS

The invention is herein described, by way of example only, with reference to the accompanying drawings, wherein:

FIGS. 1 and 2 illustrate prior art wireless communication devices;

FIG. 3 illustrates a wireless communication device of the present invention.

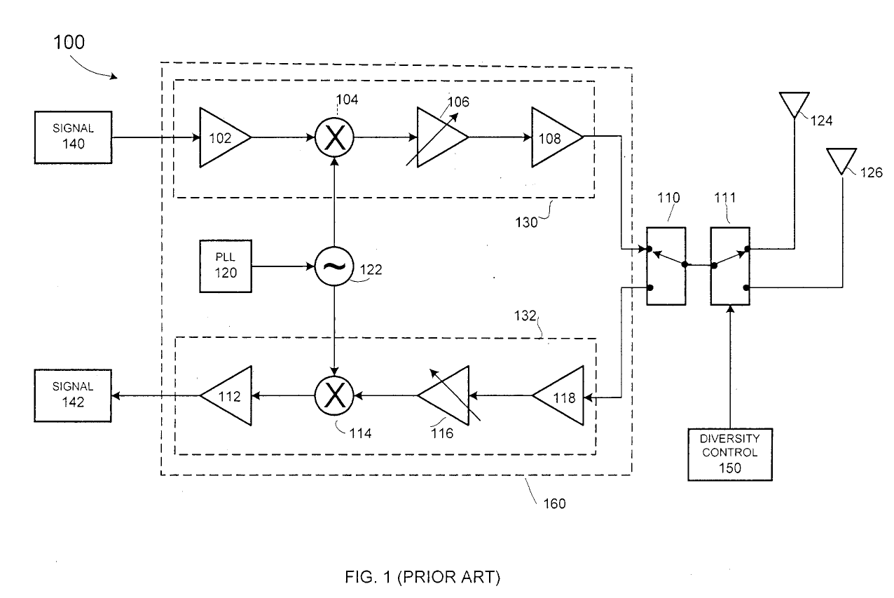

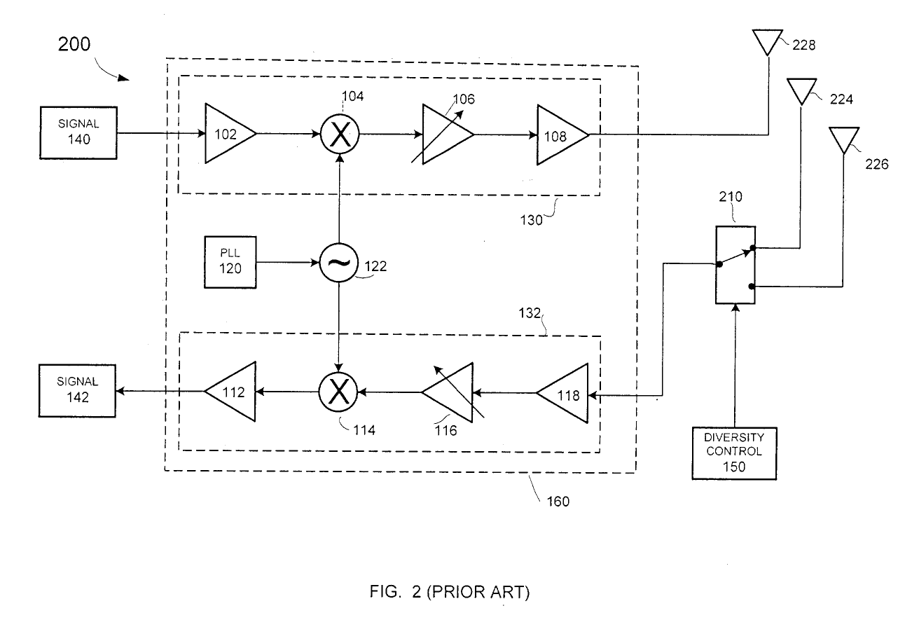

### DESCRIPTION OF THE PREFERRED EMBODIMENTS

The present invention is of a wireless communication device that can be used to decrease the cost per capacity of the associated wireless system. Specifically, the present invention can be used to decrease the number of access points needed for a WLAN of a given capacity. In addition, the devices of the present invention cost less and consume less power than comparable prior art devices.

The principles and operation of a wireless communication device according to the present invention may be better understood with reference to the drawings and the accompanying description.

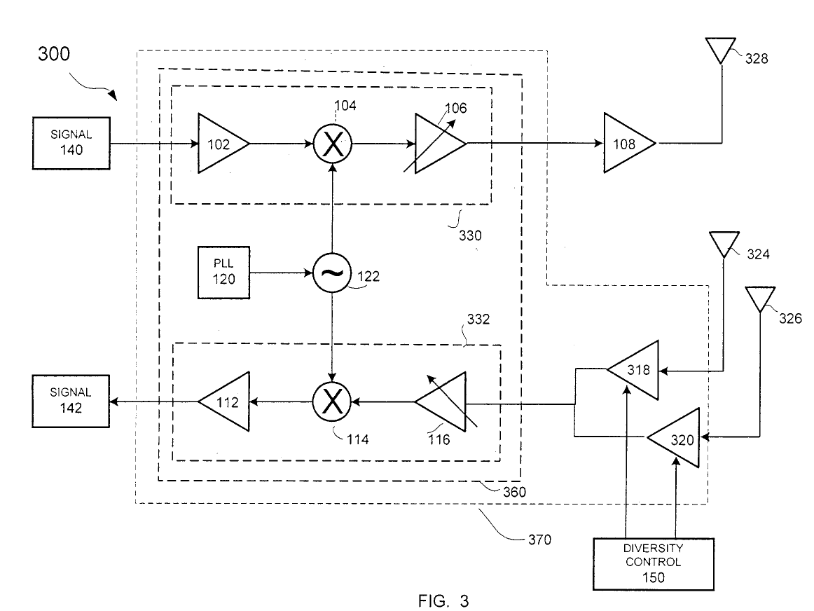

Returning now to the drawings, FIG. 3 illustrates a wireless communication device 300 of the present invention. Like prior art device 200, device 300 includes amplifier 102, up-converter 104, AGC amplifier 106, power amplifier 108 and a transmit antenna 328 for transmission of BB or IF signal 140; amplifier 112, down-converter 114 and AGC amplifier 116 for reception of BB or IF signal 142; and PLL 120 and VCO 122 for generating the local oscillator frequencies for up-converter 104 and down-converter 114.

Unlike the prior art device 200, device 300 lacks switch 210. Instead, device 300 includes two low noise amplifiers 318 and 320. Low noise amplifier 318 is coupled to a receive antenna 324. Low noise amplifier 320 is coupled to a receive antenna 326. For the purpose of defining the present invention, power amplifier 108 is considered to be separate from a transmitter front end 330 that includes amplifier 102, up-converter 104 and AGC amplifier 106; and low noise amplifiers 318 and 320 are considered to be separate from a receiver front end 332 that includes amplifier 112, down-converter 114 and AGC amplifier 116. Transmitter front end 330 transmits via power amplifier 108 and transmit antenna 328, and receiver front end 332 receives via low noise amplifiers 318 and 320 and via receive antennas 324 and 326. Transmitter front end 330 and receiver front end 332 are considered to be part of a transceiver front end 360 that also includes PLL 120 and VCO 122.

A diversity control mechanism 350 determines which of receive antennas 324 and 326 is receiving the stronger signal, i.e., the larger portion of RF power in the frequency band in which device 300 is intended to receive. Diversity control mechanism 350 then provides operating power only to the corresponding low noise amplifier 318 or 320. In this manner, only whichever of receive antennas 324 and 326 receives the most RF power in the desired frequency band is used to receive RF signals, and receive diversity is achieved.

With no switches in its reception path, device 300 saves 1.5 dB vs. device 200 and 3 db vs. device 100. For wireless LAN applications such as IEEE 802.11a+b+g, and for other similar applications, this yields an approximately 12% increase in indoor coverage range over systems that are based on device 200, and an approximately 25% increase in indoor coverage range over systems that are based on device 100. Alternatively, the receive sensitivity is increased by 1.5 dB over device 200 and by 3 dB over device 100. Among the benefits of such an increased receive sensitivity are a wider design margin, increased robustness of an associated WLAN system, and the provision of increased flexibility in OEM product design.

Device 300 has one more low noise amplifier than device 200, but lacks switch 210. Because high frequency switches tend to be more complicated than low noise amplifiers and to cost more than low noise amplifiers, device 300 is less complicated than device 200 and costs less than device 200. Preferably, low noise amplifiers 318 and 320 are fabricated along with transceiver 360 on a common RFIC chip 370 that preferably is silicon-based. Such system integration is impossible in devices such as device 100 and 200, because low-loss RF switches such as switches 110, 111 and 210 typically are manufactured using GaAs technology and so must remain external to a silicon-based RFIC chip.

As noted above, the scope of the present invention includes a WLAN whose transceivers are devices 300. For example, end station units 10, 12 and 14 of U.S. Pat. No. 6,069,887, which patent is incorporated by reference for all purposes as if fully set forth herein, could be devices 300.

While the invention has been described with respect to a limited number of embodiments, it will be appreciated that many variations, modifications and other applications of the invention may be made.

What is claimed is:

1. A wireless communication device comprising:
(a) a transceiver front end including a receiver front end; and
(b) at least two receive antennas, each said receive antenna operationally connected to said receiver front end only via a respective low noise amplifier.

2. The wireless communication device of claim 1, wherein said transceiver front end also includes a transmitter front end, the device further comprising:
(c) a transmit antenna operationally connected to said transmitter front end.

3. The wireless communication device of claim 2, wherein said transmit antenna is connected to said transmitter front end only via a respective power amplifier.

4. The wireless communication device of claim 1, further comprising:
(c) a mechanism for achieving receive diversity by alternately providing operating power to only one of said low noise amplifiers.

5. The wireless communication device of claim 4, wherein said mechanism is operative to measure periodically respective RF power received by each of said receive antennas, said operating power then being provided only to said respective low noise amplifier of said receive antenna that receives a largest said respective RF power.

6. The wireless communication device of claim 1, wherein said transceiver front end and said low noise amplifiers are integrated in a single common RFIC chip.

7. The wireless communication device of claim 6, wherein said RFIC chip is silicon-based.

8. A WLAN comprising the wireless communication device of claim 1.

9. A method of operating a RF receiver front end, comprising the steps of:
(a) providing at least two receive antennas, each said receive antenna operationally connected to the receiver front end only via a respective low noise amplifier;
(b) selecting only one of said receive antennas to receive RF signals; and
(c) providing operating power only to said respective low noise amplifier of said selected receive antenna.

10. The method of claim 9, wherein said selecting includes the step of measuring respective RF signal power received by each of said receive antennas, said selected receive antenna then being said receive antenna that receives a largest said respective RF signal power.

11. The method of claim 10, wherein said RF signal powers are measured in a 5 Gigahertz frequency band.

12. The method of claim 10, wherein said RF signal powers are measured in a 2.4 Gigahertz frequency band.
